(19) United States
(12) Patent Application Publication
(10) Pub. No.: US 2008/0180453 A1
(43) Pub. Date: Jul. 31, 2008

(54) APPARATUS AND METHOD TO MINIMIZE BLUR IN IMAGERY PRESENTED ON A MULTI-DISPLAY SYSTEM

(76) Inventors: James L. FERGASON, Menlo Park, CA (US); John D. FERGASON, Cupertino, CA (US)

Correspondence Address: WARREN SKLAR;RENNER, OTTO, BOISSELLE & SKLAR, LLP, 1621 EUCLID AVE, 19TH FL, CLEVELAND, OH, 44115, US

(21) Appl. No.: 12/020,946

(22) Filed: Jan. 28, 2008

Related U.S. Application Data
(60) Provisional application No. 60/886,800, filed on Jan. 26, 2007.
(60) Provisional application No. 60/887,144, filed on Jan. 29, 2007.
(60) Provisional application No. 60/975,382, filed on Sep. 26, 2007.

(51) Int. Cl. G09G 5/00

(52) U.S. Cl. 345/581

(57) ABSTRACT

From fast moving objects in a video image sequence may appear slightly blurred. A multi-display system including two liquid crystal displays (LCDs) viewed simultaneously via a beam combiner reduces motion blur. The displays operate in time sequential relation, e.g., by alternately and sequentially displaying an image on one LCD while blanking the other LCD and vice versa, by alternately and sequentially turning on and off respective light sources illuminating the LCDs, or by both the foregoing. Alternate sequencing also can be achieved using active shutter glasses to distinguish images for viewing based on optical polarization, possibly with a delay to allow time for image stabilization. Another approach alternates displaying odd lines on a first LCD while blanking even lines and vice versa for the second LCD; and then switching to display even lines on the first LCD while blanking odd lines and vice versa for the second LCD.

### CROSS-REFERENCE TO RELATED APPLICATIONS

This application claims the benefit of U.S. Provisional Patent Application Ser. Nos. 60/886,800, filed Jan. 26, 2007, 60/887,144, filed Jan. 29, 2007 and 60/975,382, filed Sep. 26, 2007, the entire disclosures of which are hereby incorporated by reference.

### FURTHER CROSS REFERENCE TO RELATED PATENTS AND PATENT APPLICATIONS

Examples of several embodiments of multi-displays that may be used in connection with the present invention are presented in U.S. Pat. No. 6,703,988, U.S. Design Pat. No. D533,524, and published PCT patent application publication No. WO 2006/060236. The disclosures of these are incorporated in their entireties by this reference.

### TECHNICAL FIELD

The invention relates generally to minimizing motion blur in display systems and, more particularly, to apparatus and method to minimize blur in imagery presented on a multi-display system.

### BACKGROUND OF THE INVENTION

An example of a 3D display system (also sometimes referred to as a stereo or stereoscopic display system or as a three dimensional display system) is available commercially under the trademark StereoMirror™. Such a 3D display system is a multi-display system in that it includes two displays. Such multi-display systems are available from Fergason Patent Properties, LLC of Menlo Park, Calif. and/or Planar Systems, Inc. of Beaverton, Oreg. As such example of a 3D displays system, it is typically based on commercially available flat panel, liquid crystal displays (LCDs). As a consequence, the StereoMirror display inherits both the advantages and the limitations of the underlying LCD technology. One such limitation is the tendency of fast moving objects within a video image sequence to appear slightly blurred (sometimes referred to as “motion blur,” “smear” or “motion smear,” etc.). Addressing this problem is useful because there are applications in which blur is considered undesirable.

For additional background reference is made to FIGS. 1-6. A representative example of a StereoMirror display 10 product is illustrated in FIGS. 1-3. The two flat panel LCDs (liquid crystal displays) 11, 12 in the StereoMirror display 10 are identical. Some relevant details of one of the possible physical configuration of the StereoMirror display 10 are illustrated in FIG. 2. The LCDs 11, 12 are flat panel displays, and the display surfaces 11s, 12s of the flat panel display screens have been oriented such that they are at an angle A with respect to one another. In the illustration, this angle A is on the order of about 120°. A beam combiner 13 (sometimes referred to as a beam splitter) has been positioned to bisect the angle A between the two component displays 11, 12. It may be a partially silvered mirror that transmits half of incident light and reflects the other half. Other types of beam combiners may be used. It is usual for the light output by a commercial LCD to be linearly polarized. As an example, the axis P of linear polarization is typically oriented at an angle of 45° with respect to the vertical/horizontal edges of the display screen. An example of this is illustrated in FIG. 3 in which the axis P of linear polarization is at an angle of +45° with respect to the vertical axis V of the display screen.

Although the displays 11, 12 are shown such that one is above the other, it will be appreciated that features of the invention may be achieved using displays 11, 12 that are relatively positioned in side by side relation.

Examples of several embodiments of multi-displays that may be used as 3D displays are presented in U.S. Pat. No. 6,703,988, U.S. Design Pat. No. D533,524, and published PCT patent application publication No. WO 2006/060236. The disclosures of these are incorporated in their entireties by this reference.

As illustrated in FIG. 4, the state of polarization of light 12L transmitted by the lower LCD 12 is unaffected by transmission through the beam combiner 13 as light 12L′. It remains linearly polarized with its axis of linear polarization oriented at an angle of +45°. On the other hand, the axis of linear polarization of the light 11L from the upper LCD 11 is mirrored by reflection from the beam combiner 13 as light 11L′. This constitutes a 90° rotation. After reflection, the light 11L′ from the upper LCD is linearly polarized with its axis of linear polarization oriented at an angle of −45°.

In normal operation, the pixel arrays in the two displays 11, 12 are aligned. In presenting images, the upper display 11 presents (for example) a right eye perspective image. In this case, the lower display 12 will present a left eye perspective image. As will be appreciated and as is described in the above-mentioned documents, the image on one of the displays is inverted to align with the image from the other display. For example, the image on the upper display 11 is inverted for viewing via reflection by the beam combiner and, thus, is pixel aligned with respect to the lower display (image alignment with the lower display 12). Both displays simultaneously and continually present their respective images.

In an embodiment the displays 11, 12 may be identical. In an embodiment the pixel arrays of the displays 11, 12 may be identical. In an embodiment polarization of light, e.g., the direction of the plane of polarization of plane polarized light or other polarization characteristics of the light may be identical. Also, for example, in an embodiment if the displays 11, 12 are the same, e.g., identical, and they are aligned such that the respective tops are adjacent and the respective bottoms are relatively remote, as is illustrated in FIG. 1, then for the mentioned image inverting the image on the upper display may be inverted left to right to provide for general alignment of the images as viewed by a viewer 19, respectively, via the beam combiner 13 by reflection and transmission. Other arrangements and alignments also may be used.

The viewer 19 (FIG. 4) wears glasses 20 with passive polarizing lenses 21, 22. The lens 22 on the right eye is a linear polarizer with its axis of linear polarization oriented at −45°. The lens 22 of the left eye is a linear polarizer with its axis of linear polarization oriented at +45°. In this way the right eye image from LCD 11 is transmitted through to the right eye but blocked to the left eye and vice versa. The result is that the viewer 19 is presented a stereo pair which is interpreted as a 3D image.

Note that there is a second mode of operation possible with the StereoMirror display 10 in which it produces a 2D image. In this configuration, both LCDs 11, 12 display identical images and the viewer 19 does not wear polarizing glasses 20.

Since it is built from commercially available flat panel liquid crystal displays, both the 2D and 3D images produced by the StereoMirror display (sometimes referred to as monitor) is dependent on the image qualities of the component LCDs 11, 12. This directly leads to production of an image with good brightness, a wide color gamut, high contrast as well as other superior image qualities. On the other hand, the StereoMirror display 10 is limited by other image metrics of the component LCDs 11, 12. Of relevance, is the “slow” response time of LCDs, as is discussed further below, e.g., relative to some other types of displays, e.g., cathode ray tube (CRT) displays.

One example or possible definition of LCD response time is illustrated in the two graphs 30, 31 of FIG. 5. As shown in FIG. 5 for a “normally white” LCD (also sometimes referred to as “normally bright”), the “turn off time” in graph 30 is that required after the application of the drive voltage (graph 31), e.g., following time t₁, for a pixel to optically switch from its 90% brightness state (t₂) to its 10% brightness state (e.g., the dark state relative to the 90% brightness state) t₃. Reference to brightness state sometimes is referred to as transmission state, e.g., the 90% brightness state has greater light transmission through an LCD than does the 10% brightness state. Thus, the turn off time duration is time between t₂ and t₃. Sometimes an LCD in which pixels are dark when voltage is applied to them are referred to as LCDs that operate on a “drive to dark” principle and sometimes are referred to as “normally bright” displays, as is mentioned just below. The “turn on time” for such drive to dark LCDs is that required after application of the low voltage (which may be 0 volts) at time t₄ for a pixel to optically switch from its 10% brightness state at time t₅ to its 90% bright state at time t₆. Thus, turn on time is the duration between times t₅ and t₆ in FIG. 5. Note that other definitions of switching time are possible. Examples of other common definitions include defining the limits at the 1% and 99% brightness points or even the 0% and 100% brightness points. The low voltage may be 0 volts or some other voltage that is smaller than the relatively larger voltage, which drives the LCD to dark in the drive to dark example, as was mentioned above.

Brightness state, e.g., bright/white or dark, concerns light transmission characteristic of a transmissive type of LCD itself (or reflection characteristic for a reflective LCD); brightness state does not necessarily mean the brightness of the light source that illuminates the LCD.

Some commercially available LCDs are typically made with the unpowered state as the dark state. This is called “normally dark”. An LCD can, however, be made with the unpowered state as the bright state. This is called “normally bright”. In the discussion that follows, the text and illustrations of FIGS. 5 and 6 are based on the normally bright case as an example. The turn on time in a normally bright LCD is the turn off time in a normally dark LCD and vice versa.

In commercial quality LCDs, the turn off response time is on the order of 2-5 milliseconds, e.g., represented in the graphs of FIG. 5 between times t₂ and t₃. The turn on response time (in a sense to relax to the brighter transmission state) is on the order of 5-10 milliseconds. These figures refer to typical times to transition from 10% to 90% transmission or brightness states, e.g., from time t₅ to time t₆. The times required to transition from 0% to 100% are much longer, e.g., from time t₄ to time t₇ in FIG. 5. The first significance of these numbers is that the turn off time is much faster than the turn on time. The second significance of these values is revealed when they are considered with respect to the frame time. Frame time refers to the length of time a video image is displayed on the screen before it is updated; and in the description below reference to frame may be, for example, with respect to such frame time and the operation of LCDs during that frame time, e.g., being blanked, producing an image, having selective odd/even line blanking, etc., as is described further below. As an example, some conventional LCDs refresh 60 times per second, and, therefore, each frame is 16.6 milliseconds long. This means that pixels can actually be in transition between brightness states during a significant portion of a frame. In FIG. 5 the duration of a video frame F is illustrated and labeled “video frame,” e.g., from time t₁ until time t₄. The actual time of a video frame may be longer or shorter than that illustrated or the 16.6 milliseconds mentioned.

One consequence of the “slow” response time in a LCD is that objects moving rapidly within a video frame sequence can appear blurred or smeared (“motion blur” or “motion smear” as was mentioned above). This is explained with reference to FIG. 6, which illustrates, for example, images of objects on an LCD. The top of the figure illustrates the ideal appearance of an object 40 (e.g., as represented by a rectangle formed by a group of energized, dark/black pixels) that is stationary and an object 41 (represented by another group of energized, dark/black pixels) that is moving rapidly from left to right across a row 42 of pixels of an otherwise bright (e.g., normally bright) pixel array 43 representation of an unenergized LCD 44 display screen 45. The row 46 of pixels near the bottom of the figure illustrates the actual appearance of these objects to demonstrate the motion blur effect. The feature 47 to the left of the moving object 41 is referred to sometimes as a so called “comet tail”. The “head” of the comet is the position of the object 41 during the current frame (it is shown in solid black, as that is where the object actually should be shown on the LCD 44). The pixels 47 to the left, in the tail of the so-called comet, are at the positions at which the object 41 had been located during previous frames of operation of the LCD 44. After the object 41 moved on, during the subsequent frame(s) the pixels 47 proceed to transition from their full dark, energized state to their full bright, unenergized state. Those pixels in the group of pixels 47 that are further from the head 41 have had a longer amount of frame time to complete the transition and are, therefore, brighter; and those pixels closer to the head have had less frame time to complete the transition to bright and are, therefore, less bright (that is, they are darker). This can be seen in the graduation of gray scale seen from the brighter left side 47L of the group of pixels 47 to the darker pixels at the right side 47R of the group of pixels 47. Note that in the proposed example the extent of the problem, that is, the size of the comet tail 47, is due to and a function of the slower, turn on transition time of the respective LCD pixels. The size of the comet tail may be a function of the speed at which the object 41 is moving in the sequence of images shown on the display and the operating characteristics or parameters of the display.

Next in this discussion, consider a specific but representative example of an application in which blur is an issue. The application is the identification and analysis of small objects on a large map that is shown on a display, for example, a StereoMirror display that can be operated both in 2d (two-dimensional) mode or 3D mode. In this application, the common procedure is to first locate the object. In actual practice this is done by rapidly panning across a 2D image of the large map. Once the object's location has been identified, the display is switched to 3D mode for detailed analysis of the object. The salient point is that blur is not an issue when the operator is using the StereoMirror display in the 3D mode in which there may be no motion or slow motion. Blur is an issue only when the StereoMirror display is panning in the 2D mode. Similar motion blur may occur in a 2D display

It will be appreciated that there is a need to reduce or to overcome motion blur in displays.

There also is a need to minimize blur in the 2D image panning mode of a StereoMirror display.

An aspect of the present invention relates to a method of reducing blur in a displays system, comprising using at least two displays displaying a sequence of frames representing an image on respective displays, including displaying one part of an image on one display and a second part of an image on a different display, and combining the images; and repeating the foregoing in subsequent frames.

Another aspect relates to the respective parts of the image are groups of odd lines and groups of even lines of the image.

Another aspect relates to said displaying comprising alternately displaying at least part of an image on one display while blanking at least part of the image from the other display and vice versa.

Another aspect relates to alternately displaying comprising alternately and sequentially displaying.

Another aspect relates to the blanking comprising turning off a light source that illuminates a respective display.

Another aspect relates to the blanking further comprising driving respective lines of the display to a condition such that light is not primarily transmitted or reflected at such lines.

Another aspect relates to the blanking comprising driving respective lines of the display to a condition such that light is not primarily transmitted or reflected at such lines.

Another aspect relates to the blanking comprising displaying one group of lines on one display wile displaying imagery on another group of lines of the display and vice versa for the other display.

Another aspect relates to the blanking comprising using eyeglasses having respective lenses alternately and sequentially to transmit or to block, respectively, images from respective displays based on optical polarization.

Another aspect relates to the using eyeglasses comprising using active light shutter lenses.

Another aspect relates to the using active light shutter lenses further comprising providing a delay period for stabilizing of an image on a display prior to opening a respective lens to transmit light from such display.

Another aspect relates to using the at least two displays to display a sequence of frames representing images to provide a combined 2D image.

Another aspect relates to using the at least two displays to display a sequence of respective frames representing images to provide a combined 3D image.

Another aspect relates to the images on both displays are substantially the same but are differentiated as respective left eye and right eye views to provide a 3D image.

Another aspect relates to the images on both displays are substantially the same and combine as one image via the combining step, and while one part of the image is displayed by one display the other part of the image is displayed by the other display, and vice versa.

Another aspect relates to a display apparatus comprising a plurality of displays, an image combiner to combine images from the two displays, and a control for controlling operation of the displays to display respective images or portions of images for viewing in such matter as to reduce blur.

Another aspect relates to the control comprising a computer, circuitry and/or programming selectively to provide for showing sequentially at least respective parts of an image on one display while blanking the showing of at least other respective parts of an image on said one display, and vice versa with respect to the other display.

Another aspect relates to the control controls operation of the displays to display respective portions differentiated by respective lines.

Another aspect relates to the control is adapted to drive respective display lines to dark.

Another aspect relates to the control is adapted to turn off respective light sources to respective displays.

Another aspect relates to a method of displaying images, comprising providing images on two displays controlled to display respective images or portions of images for viewing to reduce blur.

Another aspect relates to the displays present respective images in alternating sequential relation.

Another aspect relates to a display system comprising a pair of displays, a pair of active shutter lenses, and a control for controlling the opening and closing of the active shutter lenses in relation to the operation of the displays to reduce motion blur.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

Features that are described and/or illustrated with respect to one embodiment may be used in the same way or in a similar way in one or more other embodiments and/or in combination with or instead of the features of the other embodiments.

It should be emphasized that the term “comprises or comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the annexed drawings,

FIG. 1 is a front elevation view of a multi-display system having two displays such that one is above the other;

FIG. 2 is schematic illustration of a multi-display system showing the positional relation of several parts thereof;

FIG. 3 is a schematic illustration of linear polarization output from a liquid crystal display;

FIG. 4 is a schematic illustration of a multi-display system and a viewer;

FIG. 5 is a schematic representation of several graphs depicting response time in a LCD and also illustrating exemplary video frame time;

FIG. 6 is a schematic representation of a liquid crystal display, the upper portion depicting an ideal display that does not encounter motion blur and the lower portion depicting the effect of motion blur and a comet head and comet tail type of effect;

FIG. 7 is a schematic illustration of a multi-display system providing for motion blur reduction using alternate time sequentially displayed images;

FIG. 8 is a schematic illustration similar to the multi-display system of FIG. 7 using alternate time sequentially operating light sources;

FIG. 9 is a schematic representation of two liquid crystal displays and respective display lines thereof for use in a multi-display system that provides for reduction of motion blur by alternately time sequentially presenting image information are respective odd and even lines of the displays; and

FIG. 10 is a schematic illustration of a multi-displays system using active lenses (shutters) for viewing.

### DESCRIPTION

In the drawings like reference numerals designate like parts in the several drawing figures; and primed numerals are used to designate parts that are similar to other parts, which in turn are designated by the same unprimed reference numerals.

There are several approaches to the suppression of motion blur in a StereoMirror display.

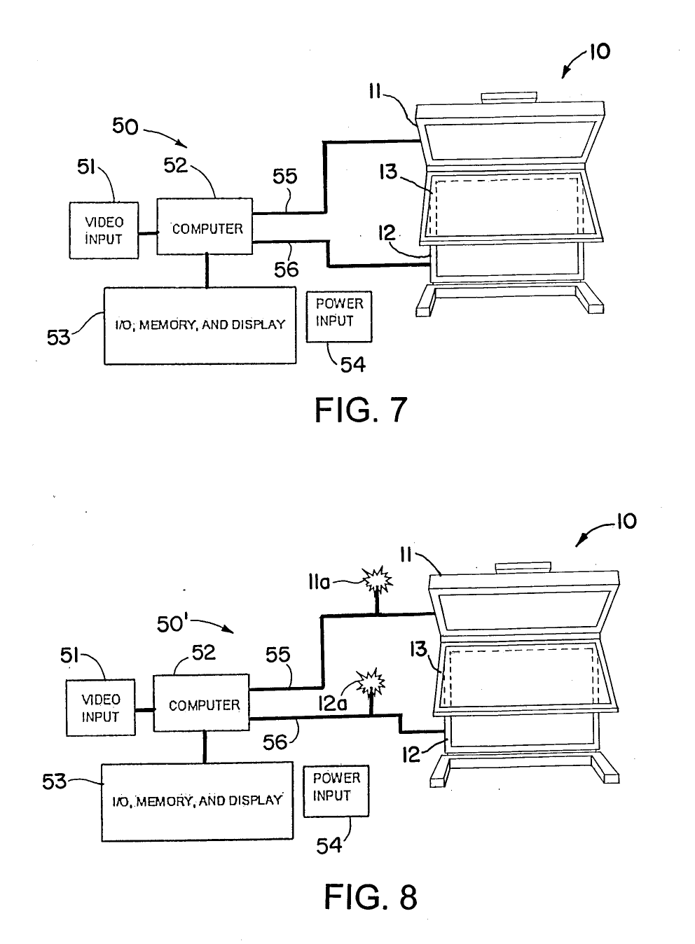

Referring to FIGS. 7-9, a multi-display system 10 is illustrated schematically. In these embodiments of the invention the viewer 19 does not have to wear glasses 20. The pixel arrays within the two LCDs 11, 12 are carefully aligned such that as viewed, images provided by those LCDs would at least substantially align pixel by pixel as viewed via the combiner 13, and the image provided by one display would be inverted relative to the image provided by the other display, as was described above.

### Alternately Blank the LCD Display Screens—See FIG. 7 and Chart 1:

According to an exemplary embodiment of the invention, during a first frame, the image is displayed by the upper LCD 11 while the lower LCD 12 is blanked. Blanked means that all pixels are driven to the full black state. Both eyes see the image; the image arrives by reflection by the combiner 13 from the upper LCD 11; although the viewer 19 also may see the lower LCD 12, the screen of that LCD is blanked and, therefore, is black, and, thus, would not contribute image information to the viewer. During a subsequent, second frame, the upper LCD 11 is blanked and the lower LCD 12 displays the image. Once again, both eyes see the image, this time from the lower LCD 12 that is viewed by transmission through the combiner 13, rather than being reflected by reflected. The LCDs continue to alternate, presenting images frame sequentially. The human eye and brain integrate the alternating images into a continuous video sequence. This operation is summarized in Chart 1.

Chart 1—depicts the above-described method, as follows:

| Frame # | 1 | 2 | 3 | 4 | etc . . . |
|---|---|---|---|---|---|
| LCD 11 | Image | Blank | Image | Blank | etc. |
| LCD 12 | Blank | Image | Blank | Image | etc. |

The reason that this approach reduces blur is that at the end of the frame, the LCD presenting an image has its image removed by a transition from the bright state to the full dark, blanked state. This transition is the faster, e.g., turn off time in a drive to dark display. By forcing the transition to be completed as fast as possible there is a reduction in the amount of light “leakage” into the subsequent frame thus reducing the size and visibility of the comet tail.

Turning to FIG. 7, a multi-display system 50 for carrying out the above-described method is illustrated. The system 50 includes a multi-display 10 having a pair of LCDs 11, 12 and a beam combiner 13. A video input 51 is provided. The video input may be a video signal or any other signal that is suitable to provide for operation of the LCDs 11, 12 to display images. The video input may be from any source, such as a cable television connection, satellite television connect, DVD, a computer, or any other source of suitable signals that may be used to provide images on the LCDs 11, 12. A computer 52 receives the video input and provides signals to the LCDs 11, 12 to operate them as was described above. The computer 52 may be a programmable digital computer or any other computer, programmable gate array, logic device, application specific integrated circuit (asic), or any other device (collectively referred to as “computer” below) that provides signals to operate the LCDs 11, 12 as described. Input/output (I/O) circuitry 53 is coupled to the computer to provide suitable inputs to the computer, such as from a keyboard, mouse, or other local device or from a remote device to set up operation of the computer. The I/O circuitry 53 may include a memory to store program information as to how the computer would operate the LCDs 11, 12, e.g., sequentially alternately, as is described above or in some other manner. The memory also may include respective buffers for signals that are to be provided to the LCDs. The keyboard may afford a user opportunity to provide desired operational or other inputs to the computer. The I/O also may include a display to allow a user to see what configuration setup or operation currently is in use by the computer and for other purposes for which computer displays typically are used. A suitable source of power 54 is provided the multi-display system 50. The computer 52 is coupled via electrical cables 55, 56 or by some other local or remotely operated connection to the respective LCDs 11, 12 to provide inputs thereto to provide respective images on the screens thereof and/or to blank respective LCDs, as was described above. An example of blanking an LCD is presented above, e.g., by grounding or providing other suitable electrical connection or input signal to the drive elements, e.g., the transistors, of the LCD so that the pixels thereof tend not to transmit light (or if a reflective display tend to not reflect light). For example, by providing a suitable control input to the transistor that operate respective pixels of an LCD, a relatively high voltage may be applied to the pixel(s) to drive them to dark, e.g., as was mentioned above. Other approaches to effect blanking of the LCD may be used, as desired.

In operation of the multi-display system 50, the computer 52 may be suitably programmed or operated to provide signals to the LCDs 11, 12 to operate them in the manner described above. Suitable computer program software for the computer 52 to carry out the functions described above may be written by a person having ordinary skill in the art to obtain such operation. Also, it will be appreciated that the computer 52 may be used in connection with other embodiments of the invention; and suitable computer program software may be written by a person having ordinary skill in the art to carry out the various operations and functions that are described with respect to such other embodiments and equivalents thereof.

### Alternately Turn Off the Back Lights for the LCDs 11, 12—See FIG. 8 and Chart 2:

In another exemplary embodiment of the invention, an alternative to blanking the respective displays 11, 12, which was described above, is to turn off the back light for the respective LCD 11, 12 that is to be dark while the other LCD is providing an image output. This approach has the potential advantage, especially when the backlight is light emitting diode (LED) based, of an even faster transition to the dark state than blanking an LCD. The result is an even greater reduction of the size and visibility of the above-described comet tail. The time required for a back light, e.g., an LED, to turn on or off may be shorter than the time required for an LCD to switch from one light transmitting state to the other, especially compared to the relatively long time required for many LCDs to relax to its undriven condition, e.g., to bright in a drive to dark type LCD.

Chart 2—depicts the above-described method, as follows:

| Frame # | 1 | 2 | 3 | 4 | etc . . . |
|---|---|---|---|---|---|
| LED 11a | On | Off | On | Off | etc. |
| LED 12a | Off | On | Off | On | etc. |

A multi-display system 50′, which is similar to the multi-display system 50 described above, provides for the computer 52 to operate respective light sources 11a, 12a, for example, according to Chart 2 above. The light sources may be one or more light emitting diodes (LEDs) or may be another type of light source. The computer 52 is coupled to the LEDs 11a, 12a, e.g., by suitable electrical connections 55′, 56′ to provide power from the power source 54, for example, to operate them by turning one on to provide a light output to illuminate a respective display and the other off during one frame of the sequence of images from the video input 51, for example. In the next frame the LEDs are reversed in that the one that had been on is off and the one that had been off is on to provide light to the respective display that it illuminates. Each LED 11a, 12a may be a number of LEDs, as may be needed to illuminate the respective LCD 11, 12. During such operation it may be that the video input is provided by the computer 52 simultaneously to both displays and the sequential operation allowing a viewer 19 to see one and then the other display in continuing sequence is provided by the alternate sequential energization of the respective LEDs 11a, 12a to provide light or to be dark. Ordinarily, when an LED is off such that an LCD is not being illuminated, the viewer would not see an image on that LCD (or at least if an image were seen due to some light leakage, the image likely would be rather dim or dark) even if image data were being provided to that LCD while the LED is off.

In operation of the multi-display system 50′, the computer 52 may be suitably programmed or operated to cause the LEDs 11a, 12a sequentially alternately to be on to provide light output or to be off, as was described above.

### Blank the Screen and Turn Off the Back Light

In another exemplary embodiment of the invention it is further possible both to blank the display and to turn off the back light at the end of the display frame, e.g., the frame that was being shown by and viewed from a respective LCD. Thus, the features and operation described above with respect to both FIGS. 7 and 8 may be used together. This double extinction of the unwanted image, e.g., the one from the blanked display of the FIG. 7 embodiment or the non-illuminated display of the FIG. 8 embodiment, may provide for a superior suppression of the comet tail effect than either of the FIG. 7 or FIG. 8 embodiments alone. Operation would be according to a combination of Chart 1 and Chart 2, whereby, while a LCD is providing an image its associated LED is on; and while an LCD is blanked its associated LED is off.

A somewhat different approach to those described above is described below using selective line blanking.

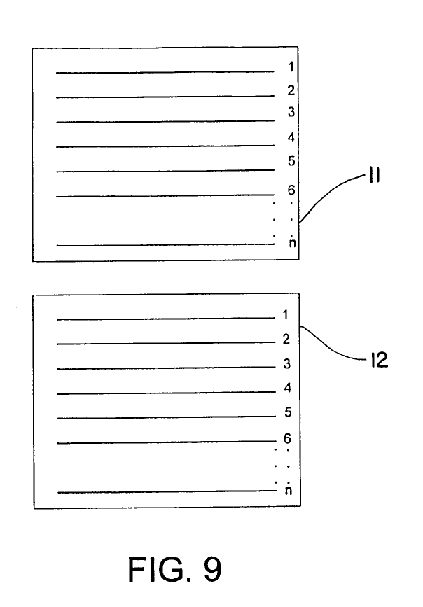

### Motion Blur Reduction Using Selective Line Blanking—See FIG. 9

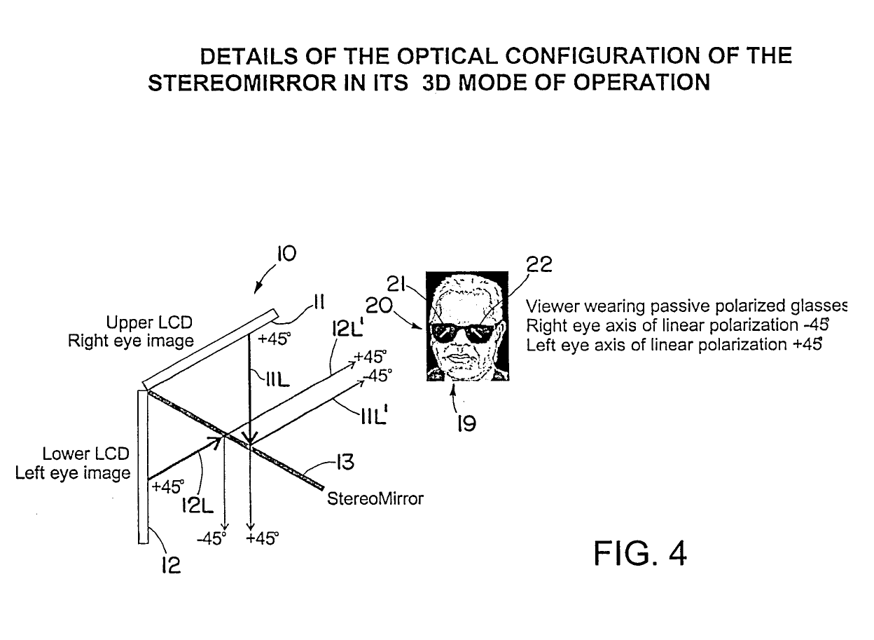

In this exemplary embodiment the viewer 19 (see FIG. 4) does not have to wear polarizing glasses 20. In FIG. 9 an enlarged view of the LCDs 11, 12 is illustrated to show a number of lines of the display that are labeled 1, 2, 3, 4, 5, 6 . . . n. During a first frame, the upper LCD 11 presents the even numbered lines (sometimes referred to as even “rows”) of the image, e.g., lines 2, 4, 6, . . . etc., while the lower LCD 12 presents the odd numbered lines (sometimes referred to as odd “rows”) of the image, e.g., 1, 3, 5, . . . etc. The human eye and brain will integrate these two images into a single, complete image as they are viewed in transmission and reflection, respectively, via the beam combiner 13.

During a subsequent, e.g., second, frame, the upper LCD 11 presents the odd rows of the image and the lower LCD 12 presents the even rows of the image. As before, the human eye and brain will integrate these two images into a single, complete 2D image. The computer 52 and associated components thereof, e.g., video input 51, I/O 53, power supply 54, and connections 55, 56, e.g., as is illustrated in FIG. 7, may be used to operate the LCDs 11, 12 in the alternate line manner described herein.

Note that whether the odd rows are blanked before the even rows or the even rows before the odd rows would not be critical.

To continue with the example, the way that this approach can be made to reduce blur is, at the end of the first frame, to blank the even rows of the upper LCD 11 and the odd rows of the lower LCD 12 while at the same time writing the odd rows of the upper LCD 11 and the even rows of the lower LCD 12. The rows that are written to (and are not blanked) will display image. Blanking may be carried out, for example, as was described above, although instead of blanking an entire LCD, only odd numbered or even numbered lines (rows) would be blanked, as described; and image data would be provided the other lines of the LCD. The procedure continues in a similar manner at the end of each frame. As before, by proceeding in this way, the image is removed by a transition from the bright state to the dark state. This transition is the faster, turn off time. By rapidly completing the transition there is a reduction in the amount of light “leakage” into the subsequent frame, thus reducing the size and visibility of the comet tail.

### Viewer Wears Passive Polarizer Glasses and Motion Blur Reduction Uses Selective Line Blanking—See FIG. 9

In another exemplary embodiment the viewer 19 does wear glasses 20 with passive polarized lenses 21, 22, e.g., as is illustrated schematically in FIG. 4. This method of blur reduction applies to the StereoMirror Display (multi-display) 10 in both the 2D (two dimensional) and 3D (three dimensional) modes of operation.

With reference to FIG. 9, for example, during a first frame, the upper LCD 11 presents (shows or displays) the even rows 2, 4, 6, . . . etc. of the image while the lower LCD 12 presents (shows or displays) the odd rows 1, 3, 5, . . . etc. of the image. The left eye sees only the left eye perspective and the right eye sees only the right eye perspective. The human eye and brain will integrate these two images into a single, complete image. If the images presented on the two LCDs 11, 12 are identical or substantially identical as to represent a 2D image, then the viewer 19 would see a 2D image; but if the images on the two LCDs 11, 12 are, respectively, left eye and right eye images of a stereo pair of images, for example, then the viewer would see a 3D (stereo) image.

During a subsequent, second frame, the upper LCD 11 presents the odd rows of the image and the lower LCD 12 presents the even rows of the image. As before, the human eye and brain will integrate these two images into a single, complete image.

To continue with the example, the way that this approach can be made to reduce blur is, at the end of the first frame, to blank the even rows of the upper LCD 11 and the odd rows of the lower LCD 12 while at the same time writing the odd rows of the upper LCD 11 and the even rows of the lower LCD 12. The procedure continues in a similar manner at the end of each frame. As before, by proceeding in this way, the image is removed by a transition from the bright state to the dark state. This transition is the faster, turn off time in a drive to dark display. By rapidly completing the transition there is a reduction in the amount of light “leakage” into the subsequent frame thus reducing the size and visibility of the comet tail.

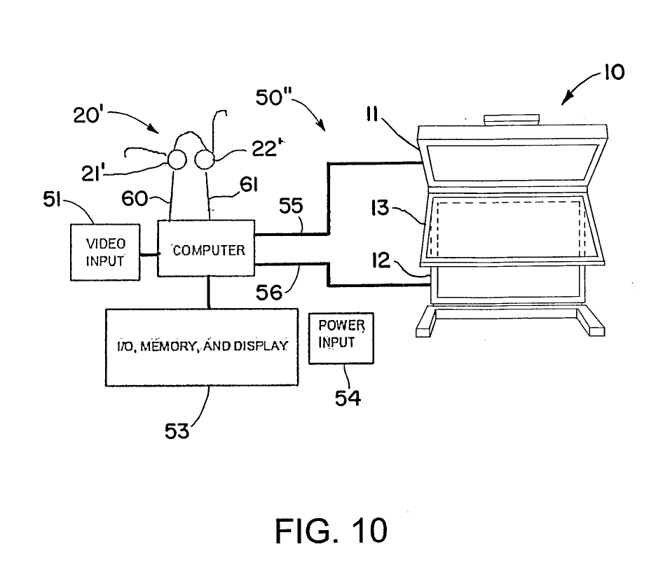

One characteristic of the time sequential approaches presented in the above-described embodiments with reference to FIGS. 7-9, for example, is that the brightness of the image is reduced at least by half. An approach or embodiment that reduces blur without necessarily as large a light loss penalty is presented below with respect to the illustration in FIG. 10.

### Viewer Wears Active Polarizer Glasses and Obtains Motion Blur Reduction—See FIG. 10

In this embodiment the viewer 19 wears active glasses 20′, as are described just below. Blur reduction can be applied to both the 2D and 3D modes. Once again, the explanation is made by use of an example.

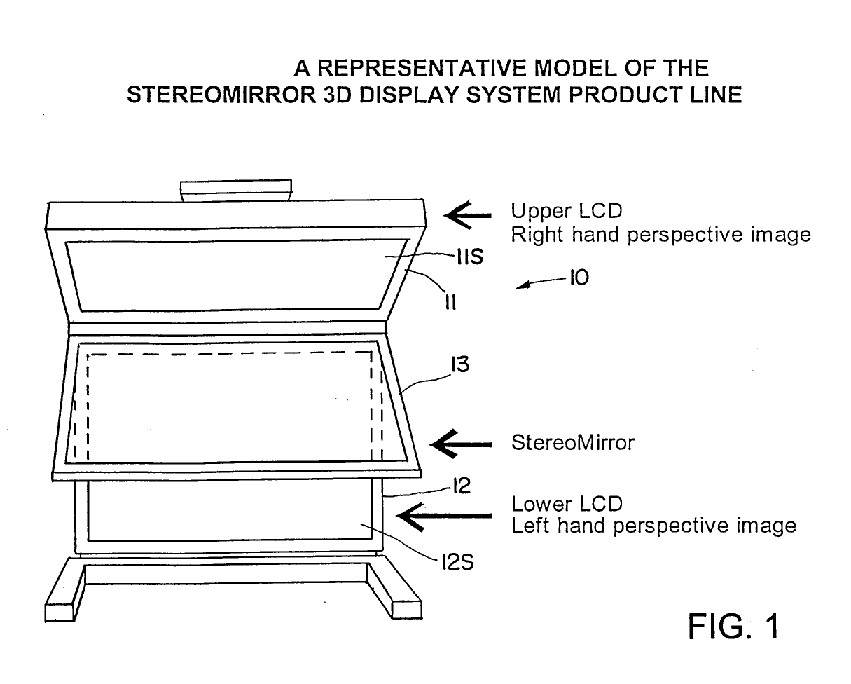

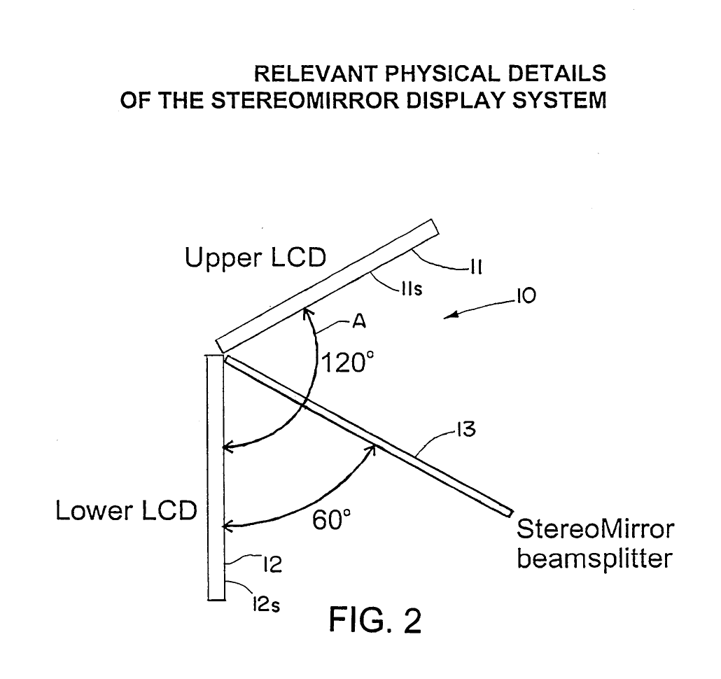

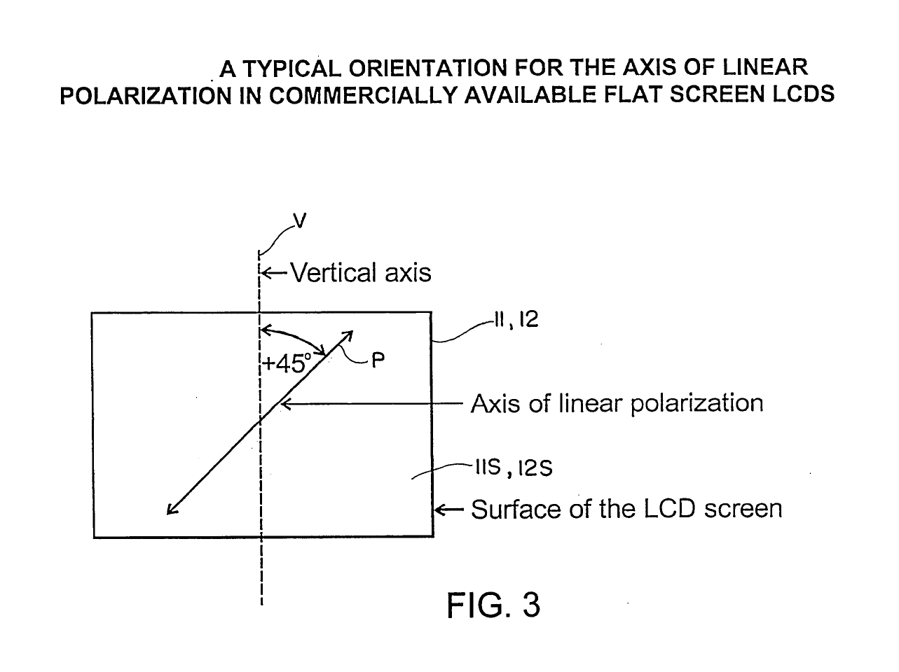

The right lens 21′ is an optical device such that in one voltage state it transmits to a user's right eye light that is linearly polarized with the axis of linear polarization at −45°, e.g., to transmit light from the display 11 (FIGS. 1, 2 and 4). In a second voltage state, the lens 21′ blocks the transmission of light. The left lens 22′ is a similar optical device but, in this case, constructed such that in one voltage state it transmits to a user's left eye light that is linearly polarized with the axis of linear polarization at +450, e.g., to transmit light from the display 12 (FIGS. 1, 2 and 4). In a second voltage state, the left lens 22′ blocks the transmission of light. The lenses 21′, 22′ are, in effect, optical shutters. If desired, other types of shutters may be used instead of those described with respect to the lenses 21′, 22′.

As a practical matter, the lenses 21′, 22′ may be a type of liquid crystal device. The desired device type is one that can quickly switch between states, e.g., as was described just above. One such device is a shutter based on the so called surface mode effect, e.g., as is disclosed in U.S. Pat. Nos. 4,385,806, 4,436,376, 4,540,243, and Re 32,521, which are incorporated by this reference in their entireties.

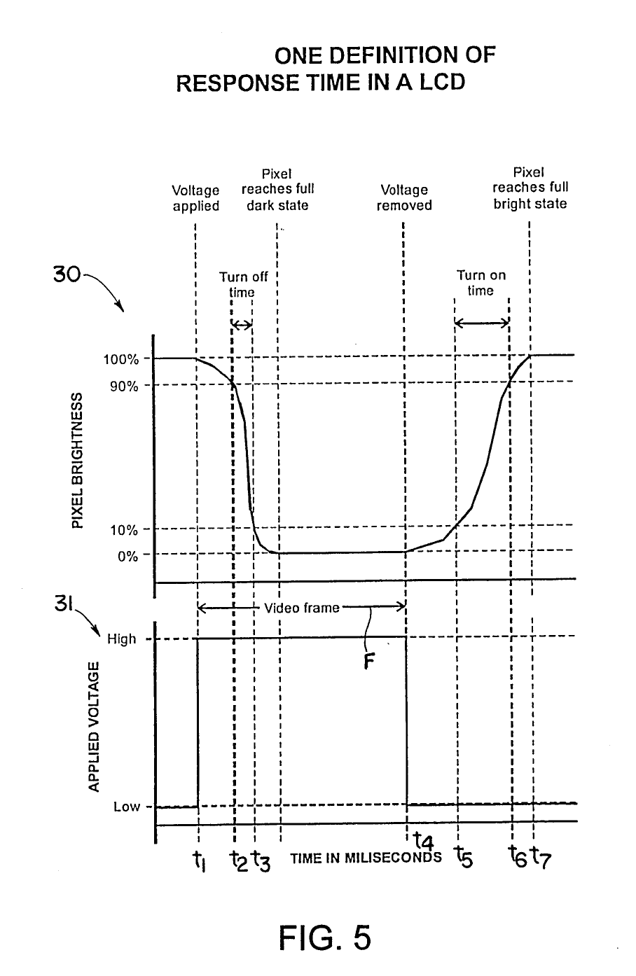

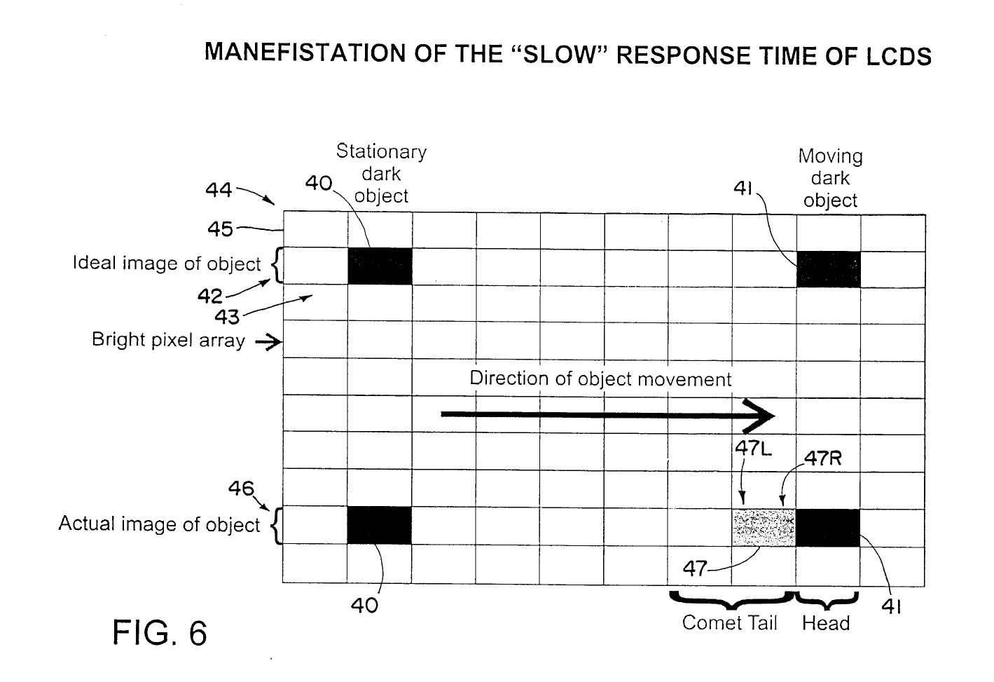

In this approach both the upper and lower LCDs 11, 12 present images simultaneously. While the LCDs 11, 12 are presenting images the shutter lenses 21′, 22′ are open and images are transmitted to both eyes. At the end of the frame, the images on the LCDs 11, 12 switch and the shutters 21′, 22′ close. At the start of the next frame new images are displayed on the LCDs 11, 12. The shutters 21′, 22′, however, do not open until the image state transition is substantially complete, e.g., see FIG. 5, which is described above. In this way, the comet tail 47 (FIG. 6) is suppressed while the amount of light loss depends on exactly when the lenses (shutters) 21′, 22′ are opened.

It is, in principle, possible to optimize the trade off between image brightness and blur reduction by adjusting the opening and closing of the shutters “on the fly” in response to the content of the image. When the image contains essentially static objects, the shutters are open during substantially the entire frame. When the image contains rapidly moving objects, the shutters would open later during the frame. One means by which such image content information could be provided to the glasses synchronization system is through the use of metadata information that is transmitted along with the video signal.

The computer 52 and parts associated therewith may be used to control both the LCDs 11, 12 and the active lenses (shutters) 21′, 22′ in the manner described above. Connections 60, 61 from the computer 52 are shown to provide for operation of the active lenses (shutters) 21′, 22′. The metadata may be information provided in the video stream that is supplied to the video input 51 (see FIG. 7) to indicate the timing relationship between the operation of the active lenses (shutters) 21′, 22′ and the LCDs 11, 12.

As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Also, although the invention is described with respect to use of liquid crystal displays as the displays 11, 12, for example, the invention may be used with other types of displays that encounter motion blur. Also, although the invention is described with respect to LCDs and linear polarization, it will be appreciated that features of the invention may be used with other than linear polarization, e.g., circular polarization, examples of which are described in several of the above-mentioned patent and patent application documents. Further, although detailed description is presented for displays that have a characteristic of being normally bright and are driven to dark, the invention may be used with displays that are normally dark and are driven to bright.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A method of reducing blur in a displays system, comprising using at least two displays displaying a sequence of frames representing an image on respective displays, including displaying one part of an image on one display and a second part of an image on a different display, and combining the images; and repeating the foregoing in subsequent frames.

2. The method of claim 1, wherein the respective parts of the image are groups of odd lines and groups of even lines of the image.

3. The method of claim 1, said displaying comprising alternately displaying at least part of an image on one display while blanking at least part of the image from the other display and vice versa.

4. The method of claim 3, said alternately displaying comprising alternately and sequentially displaying.

5. The method of claim 4, said blanking comprising turning off a light source that illuminates a respective display.

6. The method of claim 5, said blanking further comprising driving respective lines of the display to a condition such that light is not primarily transmitted or reflected at such lines.

7. The method of claim 4, said blanking comprising driving respective lines of the display to a condition such that light is not primarily transmitted or reflected at such lines.

8. The method of claim 3, said blanking comprising displaying one group of lines on one display wile displaying imagery on another group of lines of the display and vice versa for the other display.

9. The method of claim 3, said blanking comprising using eyeglasses having respective lenses alternately and sequentially to transmit or to block, respectively, images from respective displays based on optical polarization.

10. The method of claim 9, said using eyeglasses comprising using active light shutter lenses.

11. The method of claim 10, said using active light shutter lenses further comprising providing a delay period for stabilizing of an image on a display prior to opening a respective lens to transmit light from such display.

12. The method of claim 1, comprising using the at least two displays to display a sequence of frames representing images to provide a combined 2D image.

13. The method of claim 1, comprising using the at least two displays to display a sequence of respective frames representing images to provide a combined 3D image.

14. The method of claim 1, wherein the images on both displays are substantially the same but are differentiated as respective left eye and right eye views to provide a 3D image.

15. The method of claim 1, wherein the images on both displays are substantially the same and combine as one image via the combining step, and while one part of the image is displayed by one display the other part of the image is displayed by the other display, and vice versa.

16. A display apparatus comprising a plurality of displays, an image combiner to combine images from the two displays, and a control for controlling operation of the displays to display respective images or portions of images for viewing in such matter as to reduce blur.

17. The apparatus of claim 14, said control comprising a computer, circuitry and/or programming selectively to provide for showing sequentially at least respective parts of an image on one display while blanking the showing of at least other respective parts of an image on said one display, and vice versa with respect to the other display.

18. The apparatus of claim 17, wherein the control controls operation of the displays to display respective portions differentiated by respective lines.

19. The apparatus of claim 17, wherein the control is adapted to drive respective display lines to dark.

20. The apparatus of claim 17, wherein the control is adapted to turn off respective light sources to respective displays.

21. A method of displaying images, comprising providing images on two displays controlled to display respective images or portions of images for viewing to reduce blur.

22. The method of claim 4, wherein the displays present respective images in alternating sequential relation.

23. A display system comprising a pair of displays, a pair of active shutter lenses, and a control for controlling the opening and closing of the active shutter lenses in relation to the operation of the displays to reduce motion blur.
